(19) United States
(12) Patent Application Publication
(10) Pub. No.: US 2012/0004893 A1
(43) Pub. Date: Jan. 5, 2012

(54) Methods for Enabling a Scalable Transformation of Diverse Data into Hypotheses, Models and Dynamic Simulations to Drive the Discovery of New Knowledge

(75) Inventors: Akhileswar Ganesh VAIDYANATHAN, Landenberg, PA (US); Stephen D. PRIOR, Arlington, VA (US); Jijun Wang, Newark, DE (US); Bin Yu, Wilmington, DE (US)

(73) Assignee: QUANTUM LEAP RESEARCH, INC., Claymont, DE (US)

(21) Appl. No.: 12/556,591

(22) Filed: Sep. 10, 2009

Related U.S. Application Data
(60) Provisional application No. 61/218,986, filed on Jun. 21, 2009.
(60) Provisional application No. 61/097,512, filed on Sep. 16, 2008.

(51) Int. Cl. G06G 7/58; G06G 7/48; G06F 17/30

(52) U.S. Cl. 703/11; 707/739; 703/6; 707/E17.089

(57) ABSTRACT

The present invention relates to a method for the automatic identification of at least one informative data filter from a data set that can be used to identify at least one relevant data subset against a target feature for subsequent hypothesis generation, model building and model testing. The present invention describes methods, and an initial implementation, for efficiently linking relevant data both within and across multiple domains and identifying informative statistical relationships across this data that can be integrated into agent-based models. The relationships, encoded by the agents, can then drive emergent behavior across the global system that is described in the integrated data environment.

### CROSS REFERENCE TO RELATED APPLICATION

The present application claims priority from U.S. Provisional Application Ser. No. 61/218,986, filed on 21 Jun. 2009 and U.S. Provisional Application Ser. No. 61/097,512, filed on 16 Sep. 2008.

### STATEMENT REGARDING FEDERALLY SPONSORED RESEARCH OR DEVELOPMENT

Portions of the present invention were developed with funding from the Office of Naval research under contracts N00014-07-C-0014, N0014-08-C-0036, and N00014-07-C-0528.

### BACKGROUND OF THE INVENTION

Traditionally, in the progression of data to information to knowledge, the role of data, though essential, has represented an early “pit stop” on the way towards knowledge discovery. Data is typically analyzed to identify important features of the data that can then be used to develop informative models or model components. A well-constructed model represents a compact description of the underlying data, and can be used to represent the data in the knowledge discovery process.

As the volume of data has increased over recent years, however, the amount of data has posed significant bottlenecks across the entire chain represented by the progression of data to information to knowledge. Data management has become increasingly complex and expensive, and the subsequent analysis of the data has suffered as well. In addition, the ability for humans to interpret the data in order to form testable theories or hypotheses becomes more difficult when confronted with vast amounts of data.

The ever increasing volume of data therefore places significant demands on data management, data storage and data utilization. The capability of “triaging” the data environment into data subsets that are relevant to specific applications can result in a data organization and filtering that can significantly enhance the subsequent extraction of knowledge from the data. Triaging data into “relevant” and “irrelevant” subsets can potentially enhance the value of the data to an enterprise as the information is now concentrated in the relevant subset. This can result in more effective data storage and utilization by end users.

Different applications can triage the data into different subsets as the notion of data relevance is intimately related to the context of the application. For example, data about a patient that is relevant for one disease may be less relevant for another disease. Adaptive triaging of data into different subsets based on the application can result in more targeted utilization of the data. If data storage constraints are paramount, only data that is relevant for the set of applications under consideration need to be stored, thus potentially reducing data storage costs.

Existing approaches to data reduction typically involve “feature reduction” where the number of features associated with the data are reduced. Such methods do not typically filter the data at the data record level but rather reduce the number of features of each data record. Providing a “data record—centric” means for data filtering can avoid utilizing data records that are noisy for subsequent analysis. For example, building a model of adverse health events can be significantly improved if less informative data records are excluded during model building. During model utilization, test data records can be similarly triaged so that less informative test records are identified as too noisy for accurate prediction rather than being used to make a possibly erroneous prediction. In health care applications for example, making erroneous predictions can be especially harmful versus flagging additional examination of an ambiguous health record.

The present invention presents computationally efficient means for performing data filtering at the data record level. It further describes the utilization of filtered data to automatically build and use improved models, and to generate and test hypotheses. In modeling complex multi-scalar systems, existing approaches model each domain with significant detail, and subsequently link the domain models into a hierarchical manner to represent the global system. However, such an approach is inefficient in dealing with complex systems with vast amounts of data. Filtering the data using the methods of the present invention can potentially result in simpler, more informative models of complex systems where only relevant data is used to build and test models and hypotheses.

### Prior Art:

### Data Filtering & Data Relevance:

There has long been recognition of the need to remove irrelevant or noisy data from data sets, both in the case of data sets with defined target states as well in more general, unsupervised data sets with no target state explicitly defined. (Wilson, D. “Asymptotic properties of nearest neighbor rules using edited data”, IEEE Trans. on Systems, Man and Cybernetics, 2, 408-421 (1972)). Wilson (1972) has used nearest neighbor classifiers to prefilter data for subsequent classification using a second stage classifier. In Brodley, C. E. and Friedl, M. A. “Identifying Mislabeled Training Data”, J. Artificial Intelligence Research, 11, 131-167 (2005), Brodley and Friedl (2005) and references contained therein survey multiple filtering methods using ensembles of classifiers that serve as an ensemble filter for the training data. In their paper, the classification method was based on C4.5 decision trees. More generally, Brodley and Friedl describe a process whereby m learning algorithms are used to define an ensemble of classifiers that are then combined through a n-fold cross validation on the training data to filter out those data records that do not receive a requisite fraction of correct classifications. The improper classifications can be due to either a mislabeling of the target class or due to noise in the input features associated with the record of interest.

Once the first stage filtering has been accomplished, a new classifier or ensemble of classifiers can be trained on the remaining data, possibly using different classification techniques from those used during the filtering process. In the event that the target class has been mislabeled, removal of the suspect data records can improve the generalization of models trained on the properly labeled data; however, as Quinlan points out, if improper classification is due to noise in the input features associated with the training data, removing this data might not result in better models if the noise levels are high. Quinlan, J. R. “Induction of decision trees”, Machine Learning, 1, 81-106 (1986).

The implicit assumption here is that removal of noise during training without removing similar noise during testing may result in training models that do not reflect the noise inherent in the test set.

In the methods of the present invention, no classifiers are used to filter data sets: A classifier makes a prediction around the target state for a given data record. In the present invention, the mutual information of defined ranges of one or more interacting input features against the target feature is used to identify an informative filter over a set of training data. If a new data record satisfies the rules embedded in the filter by satisfying the data ranges of the corresponding input feature combination that define the filter rules, the record is deemed to be relevant, regardless of its specific target state. In the present invention, there is thus no explicit measurement or prediction of the target feature that is used to determine data relevance. As such, the method of the present invention is well suited to address the situation where the dominant error mechanism is inherent noise in the data environment rather than error in the labeling of the target feature. In contrast, the latter error mechanism provides the motivation and rationale for the prior art cited above.

In addition, the same filter or sets of filters that are identified on training data can further be applied against test data to remove noise in the test data prior to feeding the data into models developed using filtered training data. “Triaging” the data in this manner prior to evaluation by models can help alleviate the concern raised by Quinlan around the subsequent applicability of models trained on filtered training data to new data. In many applications, identification of relevant data prior to modeling can result in the significant reduction of both false positives and false negatives resulting from the modeling process. Instances of such error reductions will be presented in the present application on an example data set. We note that any modeling technique that can be applied against the unfiltered data set can be applied against the filtered data set. The data filtering step has thus been decoupled from the subsequent modeling step allowing general applicability of the methods described in the present invention.

More recently, association rules analysis has been used to filter data based on informative data associations around the input features. Xiong et al (2006) have described such an approach aimed at enhancing data analysis with noise removal. Xiong, H., Pandey, G., Steinbach, M. and Kumar V., “Enhancing Data Analysis with Noise Removal”, IEEE Transactions on Knowledge and Data Engineering, Vol. 18, No. 3, 304-318 (2006) and references contained therein. In such an unsupervised setting, the explicit linking to the class label (or “target state”) is not established during the determination of relevance. Rather, outlier behavior of the data based solely from the standpoint of the characteristics of the inputs is what is measured as the basis for establishing relevance. Xiong et al further use association rules analysis as a means for selecting individual features for relevance rather than data records in their entirety. Their approach fits the general approach of dimensionality reduction through feature selection more than the determination of whether a data record in its entirety should be triaged. This latter determination forms the basis for the present invention.

Vaidyanathan et al in U.S. Pat. No. 6,941,287 Distributed Hierarchical Evolutionary Modeling and Visualization of Empirical Data, teach methods of performing dimensionality reduction through the use of the Nishi informational metric to identify informative feature associations. They do not however teach the idea of triaging data records in their entirety to identify more relevant data subsets from a larger data environment. A key advantage of the present invention lies in the two stage process for noise filtering wherein irrelevant data records are removed in their entirety from the modeling and simulation environment and the remaining relevant data records are then further analyzed to identify the most informative feature associations. This two-stage process for noise filtering can result in models that are both more compact due to the removal of irrelevant data as well as more informative due to the identification of informative feature associations.

Thus, there is a long standing need for simplifying databases and providing a significant reduction in complexity and the resultant computational efficiency in generating models and modeling components that results from identifying the most informative statistical relationships across large and ever increasingly complex data environments.

### Modeling Complex Systems

U.S. Pat. No. 5,930,154 to Thalhammer-Reyero describes a ‘Computer-based system and methods for information storage, modeling and simulation of complex systems organized in discrete compartments in time and space.’ The patent claims a hierarchical modeling that is limited to visual representations that comprise a ‘library of knowledge-based building blocks’ that are linked to create ‘complex networks of multidimensional pathways.’ This systems-engineering approach to modeling relies on the availability or creation of a library or toolbox of ‘knowledge-based building blocks’ where the critical knowledge concerning the behavior must be specifically known in advance to generate the knowledge-based building blocks and the linkages between them that would support a simulation of the complex system.

When applied to a complex data environment such as that exemplified by many current biological systems this approach frequently results in computationally inefficient models and simulations and requires significant expertise to generate useful outputs. Moreover, this approach to modeling and simulation typically produces predictable results.

The present invention provides the important advantage of a significant reduction in complexity resulting from identifying the most informative statistical relationships across large and ever increasingly complex data environments—this approach can be contrasted with the system described by Thalhammer-Reyero where the model for each domain is modeled with significant detail and subsequently linked in a hierarchical manner to represent the global system.

The underlying premise of the present invention is based on the observation that the key emergent properties of a complex (or complex adaptive) system can be captured by modeling agent behaviors with the most informative statistical associations rather than by modeling the entire data environment and that the use of an agent-based paradigm ensures emergent rather than predictive behavior for the models and the simulation.

In a subsequent patent, U.S. Pat. No. 6,983,227, Thalhammer-Reyero describes ‘Virtual models of complex systems’ that are again focused on a typical systems-engineering approach where the design of the system results from the composition of smaller elements where composition rules depend on the reference paradigm and produce predictable results. This again contracts with the present invention which relies on agent-based modeling and emergent behavior that display nonlinear dynamics and self-organizing processes that produce results that cannot, a priori, be predicted. This latter feature is a key attribute of the complex and complex adaptive systems that the present invention seeks to model and simulate.

Furthermore, the decentralized nature of agent-based models i.e. the absence of dedicated coupling of the elements as described in Thalhammer-Reyero produces robust and scalable simulations of complex and complex adaptive systems including biological systems.

### Modeling Biological Systems:

U.S. Pat. No. 5,808,918 ‘Hierarchical biological modelling system and method’ (sic) to Fink et al describes ‘a dynamic interactive modelling system which models biological systems from the cellular, or subcellular level, to the human or patient population level’. With respect to the present invention Fink et al specify that the modeling system is limited to consideration of chemical levels, chemical production and ‘state changes regulated’ by chemical changes. This is a significant constraint on the analysis of and simulation of a biological system and fails to address key interactions mediated by mechanisms that do not require the involvement of chemicals. Examples of non-chemical reactions include, but are not limited to, cell-to-cell contact, physical stimuli (electrical, temperature, et cetera).

The present invention is not constrained to biological systems nor is it constrained to consideration of modeling by limiting the model to chemically-linked interactions. In approaching the modeling of complex, and complex adaptive, systems through the approach of creating a scalable, informative agent-based simulation system using automatically generated models that encode the informative emergent behavior of the system the present invention is much more flexible than that described by Fink et al.

The use of multiple model components to simulate a biological system has been previously described. U.S. Patent Publication 2004/0088116 submitted by Khalil et al describes “Methods and systems for creating and using comprehensive and data-driven simulations of biological systems for pharmacological and industrial applications.” Khalil et al describe a method of creating a scalable simulation of a biological system, including the integration of diverse data sources, where integrating diverse data types includes utilizing data mining tools.

With respect to the present invention Khalil et al contemplates ‘creating and using comprehensive data-driven simulations of biological systems’ wherein the data describes the biological functions that drive the simulation and requires a comprehensive dataset to effectively inform the simulation. This contrasts with the present invention wherein the data is used to automatically generate models of the data that encode the most informative statistical relationships and where these derived relationships that describe the data rather than the data itself are used to inform the model components that are used to drive the simulation.

The present invention thus provides the following advantages not contemplated in the application of Khalil et al:
Enabling partial and incomplete data to be used to inform the creation of model components and models,
Facilitating the combining or fusing of model components or models to develop rules that inform the simulation, and
Providing ‘data filtering’ that increases the ‘signal’ to ‘noise’ ratio and thus provides for computational efficiency in building model components, models and simulations.

Moreover, the present invention is significantly different from the approach described in Khalil et al in that the invention described uses the features previously noted to develop model components and models that are then used in an agent-based modeling environment where the agents generate emergent behavior from the system to support the simulation. Thus the simulation described in the present invention results from behaviors of component models and models in an emergent complex system (or complex adaptive system) that are informed by the relationships derived from the data rather than from the data itself. The underlying premise of the present invention is based on the observation that the key emergent properties of a complex (or complex adaptive) system can be captured by modeling—in a simulation—agent behaviors with the most informative statistical associations rather than by explicitly modeling the comprehensive or entire data environment.

In U.S. Pat. No. 7,415,359, Hill, et al., describes systems and methods for the ‘identification of components of mammalian biochemical networks as targets for therapeutic agents.’ This patent contemplates simulating biochemical networks ‘by specifying its components and their relationships’ and presents as an example ‘methods for the simulation or analysis of the dynamic interrelationships of genes and proteins with one another.’ The key elements of this patent include the specification of the biochemical networks of the cell and the perturbation of the networks to derive a ‘new’ simulation with properties suited to the identification of targets for therapeutic interventions. The present invention is substantially different from the Hill patent both in terms of how the simulation is generated from the data and in terms of the breadth of the biological systems that can be simulated.

As previously described the present invention is based on the observation that the key emergent properties of a complex (or complex adaptive) system can be captured by modeling—in a simulation—agent behaviors with the most informative statistical associations rather than by modeling the comprehensive or entire data environment. Thus the simulation of the biological networks is dissimilar to Hill et al in that it is driven by modeling components and models that are informed by relevant data and their associated relationships rather than by the data itself. Moreover, the range of biological systems that can be simulated using the present invention is much broader than the biochemical networks contemplated by Hill et al. For example, the invention as described in this application includes ‘networks’ that are not limited to biochemical reactions as contemplated by Hill et al but include biological networks that span the ‘-Omics Continuum’ and thus include networks with linkages that encompass a broader range than just biochemical reactions.

Finally, the present invention describes informative emergent behavior of the system that is enabled by the inclusion of either deterministic terms or stochastic terms or both deterministic and stochastic terms into the model components, models and simulations. In contrast the patent of Hill et al and the application of Khalil et al contemplate only deterministic terms for generating models and simulations thus significantly limiting the types of biological system that can be described and studied.

Prior et al in U.S. Patent Publication No.: 2005/0055188 describe methods for developing agent-based simulations for biological systems but in the context of the novel claims of the present invention do not contemplate automatically generating the model or model components from the relevant data sets. The automatic filtering and learning of the model components or models that are encoded in the ABM is an important element because of the efficiency and scalability that is derived in the present invention through the development of the key emergent properties of a complex (or complex adaptive) system using the most informative statistical associations to guide the agent behaviors in the simulation rather than by modeling the comprehensive or entire data environment.

Emergent Behavior from Agent-Based Models:

In a recent publication, Gardelli, L., Viroli, M., Casdei, M. and Omcini, A. (2008) ‘Designing self-organising environments with agents and artefacts: a simulation-driven approach’, Int. J. Agent-Oriented Software Engineering, Vol 2, No. 2, pp. 171-195, Gardelli et al provided a review of some of the key publications in the area of emergent behavior derived from agent-based models and concluded that ‘Self-organization is increasingly being regarded as an effective approach to tackle the complexity of modern systems. This approach seems to be compelling owing to the possibility of developing systems exhibiting complex dynamics and adapting to environmental perturbations without requiring a complete knowledge of future surrounding conditions. The self-organization approach promotes the development of simple entities that, by locally interacting with others sharing the same environment, collectively produce the target global patterns and dynamics by emergence. Many biological systems can be modeled using a self-organization approach.’

The development of Self-organizing Systems (SOSs) is driven by different principles with respect to traditional engineering. For instance, engineers typically design systems as a result of the composition of smaller elements, which are either software abstractions or physical devices, where composition rules depend on the reference paradigm (e.g., the object-oriented one), and typically produce predictable results. Conversely, SOSs display nonlinear dynamics, which can hardly be captured by deterministic models and, though robust with respect to external perturbations, are quite sensitive to changes in inner working parameters. In particular, engineering a SOS poses two big challenges: How can we design the individual entities to produce the target global behavior? And, can we provide guarantees of any sort about the emergence of specific patterns?’

The present invention provides a novel solution to both of these questions in a computationally-efficient manner and enables a scalable, informative agent-based simulation system using automatically generated models that encode the informative emergent behavior of the system.

### Linking Models, Model Components & Partial Models:

In its 2005 publication, Coveney, P V., and Fowler, P W., Modeling biological complexity: a physical scientist's perspective. Journal of the Royal Society Interface. Vol. 2 pp 267-280 (2005), Coveney and Fowler reviewed the current state of ‘Modelling biological complexity’ (sic) and concluded that ‘although reductionism is powerful, its scope is also limited. This is widely recognized in the study of complex systems whose properties are greater than the sum of their parts’. This is consistent with the basis for the present invention which provides a novel capability that is applicable to data derived from reductionist analysis of complex and complex adaptive systems.

With regard to the present invention Coveney and Fowler also reviewed the current status of integrating models and model components across multiple temporal and spatial scales and concluded that ‘this is clearly an immensely challenging and open-ended research programme which is generally regarded as being more difficult than the Human Genome Project ’. The present invention provides an approach not contemplated by their publication and one that represents a novel and potentially powerful approach to the emerging problem in biological sciences.

### Glossary:

Computationally efficient: Use of a computer system, having one or more processors or virtual machines, each processor comprising at least one core, the system comprising one or more memory units, one or more input devices and one or more output devices, optionally a network, and optionally shared memory supporting communication among the processors to produce the desired effects without waste.

Complex system: A complex system is a system composed of interconnected parts that as a whole exhibit one or more properties (behavior among the possible properties) not obvious from the properties of the individual parts. Examples of complex systems include most biological materials—organisms, cells, subcellular components—environment, human economies, climate, energy or telecommunication infrastructures.

Complex adaptive system (CAS): Complex adaptive systems are special cases of complex systems. They are complex in that they are diverse and made up of multiple interconnected elements and adaptive in that they have the capacity to change and learn from experience.

A Complex Adaptive System (CAS) is a dynamic network of many agents (which may represent cells, species, individuals, firms, nations) acting in parallel, constantly acting and reacting to what the other agents are doing. The control of a CAS tends to be highly dispersed and decentralized. If there is to be any coherent behavior in the system, it has to arise from competition and cooperation among the agents themselves. The overall behavior of the system is the result of a huge number of decisions made every moment by many individual agents.

(Complexity: The Emerging Science at the Edge of Order and Chaos by M. Mitchell Waldrop).

A CAS behaves/evolves according to three key principles: order is emergent as opposed to predetermined, the system's history is irreversible, and the system's future is often unpredictable. The basic building blocks of the CAS are agents. Agents scan their environment and develop schema representing interpretive and action rules. These schema are subject to change and evolution.

(Dooley, K. Accessed at http://www.eas.asu.edu/˜kdooley/casopdef.html (Accessed: Aug. 21, 2008)).

Examples of complex adaptive systems include the markets, financial markets, online markets, advertising, consumer behavior, opinion modeling, belief modeling, political modeling, and social norms and any human social group-based endeavor in a cultural and social system such as political parties or communities.

Data Management: The organization of data typically provided by a database management system.

Data Storage: The storage of data typically within a database.

Data support discontinuity threshold: A discontinuity threshold in the filter union data support used as a pre-filter to select a filter.

Data Utilization: The use of data by end-users for analysis.

Emergent Behavior: For Goldstein, emergence can be defined as: “the arising of novel and coherent structures, patterns and properties during the process of self-organization in complex systems”. Goldstein, Jeffrey (1999), “Emergence as a Construct: History and Issues”, Emergence: Complexity and Organization 1: 49-72.

“The common characteristics are: (1) radical novelty (features not previously observed in systems); (2) coherence or correlation (meaning integrated wholes that maintain themselves over some period of time); (3) A global or macro “level” (i.e. there is some property of “wholeness”); (4) it is the product of a dynamical process (it evolves); and (5) it is “ostensive”

Corning, Peter A. (2002), “The Re-Emergence of “Emergence”: A Venerable Concept in Search of a Theory”, Complexity 7(6): 18-30.

Entity: An identifiable component of the model or simulation that has separate and discrete existence. Entities are objects that are used in the model or simulation to interact with one another or the simulation environment to modify the state of one or more of the other entities in the simulation or to change the environment to influence the behavior or reaction of one or more entities in the simulation. For example for biological systems the entities include but are not limited to: molecular species, cell structures, organelles, cells, tissue, organs, physiological structures, organisms, demes, populations of organisms, ecosystems, and biospheres, the genome, the proteome, the transcriptome, the metabolome, the interactome, molecules within cells, molecules among cells, cells within tissues, cells within organs, signaling, signal cascades, messaging, transduction, propagation of information among aggregates of cells, neuron populations, cell fate, programmed cell death, epigenetics, flora and other commensal organisms, symbiotic organisms, parasitic organisms, bacteria, fungi, archaea, viruses, prions, social organisms, species, members of the animal kingdom, and members of the plant kingdom.

Ex vivo: Ex vivo refers to experimentation done in live isolated cells rather than in a whole organism, for example, cultured cells from biopsies.

Feature complexity: The number of contributing features across a set of intersecting filters.

Filter Union Data Support Score: The data support of the data subset that is generated by the union of one or more informative data filters which results in a composite union filter.

Filter Union Mutual Information Score: The mutual information of the data subset that is generated by the union of one or more informative data filters that results in a composite union filter.

Increment Level for (filter) mutual information threshold: An increment value used to loop through a range of filter mutual information thresholds ranging from a minimum filter mutual information threshold to a maximum filter mutual information threshold.

Informative Data Filter: A combination of features and states where the underlying data cluster consistent with the combination has high mutual information against a target feature.

In silico: In silico refers to the technique of performing a given experiment on a computer or via computer simulation.

Intersection of filters: The data subset that is common to multiple filters.

In virtuo: In virtuo refers to the technique of performing a given experiment in a virtual environment often generated on a computer or via computer simulation.

In vitro: In vitro refers to the technique of performing a given experiment in a controlled environment outside of a living organism; for example in a test tube.

In vivo: In vivo refers to experimentation done in or on the living tissue of a whole, living organisms as opposed to a partial or dead one or a controlled environment. Animal testing and clinical trials are forms of in vivo research.

Maximum (filter) mutual information threshold: A maximum value for the mutual information threshold of a filter used to identify a data cluster present in a data set.

Minimum (filter) mutual information threshold: A minimum value for the mutual information threshold of a filter used to identify a data cluster present in a data set.

Modality: The different forms of representation, inputs or outputs for the components or entities comprising a model or models that can be used to support visualization of the modeling or simulation environment, for example, images, text, computer language, movement, or sound.

Modeling components: Constituent parts of the model that can act on, or influence the entities in the simulation.

Mutual information discontinuity threshold: A discontinuity threshold in the filter union mutual information score used to identify an optimum filter union.

‘-Omics’ Continuum: The English-language neologism omics informally refers to a field of study in biology ending in the suffix -omics, such as genomics or proteomics. The related neologism omes addresses the objects of study of such fields, such as the genome or proteome respectively. The ‘Omics’ continuum refers to the span of omics—known or not yet defined—that describes the elements that comprise biological systems. A current list of omes and omics can be found at: http://en.wikipedia.org/wiki/list_of_omics_topics_in_biology (Accessed 21 Jan. 2009).

Relevant Data Set: The data set that results from an optimal filter union at the filter mutual information threshold where the change in filter union mutual information score exceeds the mutual information discontinuity threshold. The data that does not comprise the relevant data set is defined as the “irrelevant” data set.

Scale (Temporal and spatial): Complex and complex adaptive systems can be described as having component or constituent parts that have specific temporal or spatial scales. In developing a simulation for systems that have multiple temporal or spatial scales it is necessary to resolve potentially conflicts or disconnects between the scales of interest. Two approaches are routinely used: Hierarchical or Hybrid modeling. In hierarchical modeling the shortest length scale (time or space) is run to completion before its results are passed to the model describing the next level. In hybrid modeling the multiple scales are dynamically coupled often through the use of nested models.

Simulation entity: A self contained component that represents one of the active elements in a simulation process. An example of a simulation entity is an agent that comprises a component of an agent based model. An agent-based model (ABM) is a computational model for simulating the actions and interactions of autonomous individuals in a network, with a view to assessing their effects on the system as a whole.

Testing Data Set: The data set that is used to evaluate one or more filters and/or one or models.

Threshold Data Support level: A normalized value for the percentage of data present in a data cluster derived from a filter.

Training Data Set: The data set that is used to identify one or more filters and/or build one or more models.

Tuning Data Set: The data set that is used to optimize a model or set of models by adjustment of model parameters.

Validation: Verifying that the system complies with the desired function. In the present invention validation of the system is accomplished by comparison with results obtained from in-vitro, in-vivo and/or ex-vivo experimental studies.

### SUMMARY OF THE INVENTION

The present invention successfully addresses the data management and analysis challenges mentioned above and offers unique capabilities in identifying relevant subsets of data that may be embedded in large data environments. In so doing, the present invention transforms a database into an information or knowledge base.

The instant invention also relates to methods for enabling a scalable transformation of diverse data supporting complex and complex adaptive systems and exemplified with biological data into hypotheses, models and dynamic simulations to drive the discovery of new knowledge.

One advantage of the present invention is that the identification of feature filters is generally much simpler computationally than the cost of building ensembles of first stage classifiers, thus facilitating scalability. In data environments with a limited number of features (less than or on the order of 20 features), exhaustive methods can be used to measure the mutual information content of low order feature combinations from which filters can be extracted. For more complex data environments involving a larger number of features, genetic algorithms or other searching methods can be used to identify a set of informative feature combinations from which filters can be extracted. For many classification techniques, identifying informative features represents only the first step in model building. Following feature selection, further computational cost is incurred in building the model structures themselves. This cost can be alleviated using the methods of the present invention.

Another key advantage of the present invention is related to the capability of providing a new way of viewing distributed modeling. In the present invention, the feature filters span the input feature space. If there is sufficient coverage across the feature space, the resulting filtered data set can provide the basis for a robust model, even if the filtering results in a relatively small training set. In this sense, the term “distributed” refers to building a model using data that is filtered through feature filters that are distributed across the feature space. This is in contrast to the more conventional usage of the term “distributed” that involves building models that are further distributed across the data space. This has significant consequences for building scalable analytic solutions, since generally the number of features is much smaller than the number of data records. The underlying assumption of the present invention is that it is sufficient in general to build relatively few models that span the feature space using smaller amounts of data where the irrelevant data has been removed. Current state of art ensemble based modeling methods typically involve the generation of large numbers of models distributed over significantly larger fractions of the data space, and assume that the models act as data filters concurrently while making predictions. In the present invention, identifying informative feature filters that span the feature space provides a basis for first separating the removal of irrelevant noise from the subsequent step of building models. Viewing a model as a signal to noise amplifier, this amounts to increasing the signal to noise of an individual model significantly by first removing the noise from the data environment, before feeding the data into the amplifier. As a result, fewer and smaller models can be used to represent large data environments.

The informative feature filters described in the present invention can further be used to drive dynamic simulations directly from empirical data. An informative filter encodes probabilistic associations between a combination of input features and a target feature.

These probabilistic associations, learned directly from the data, can be invoked stochastically during a dynamic simulation by modeling entities such as agents in an agent based modeling environment to drive emergent behavior characteristic of complex, adaptive systems Linking one or more filters to dynamic data sources that are derived from either real or synthetic data, can additionally be used to drive simulations using updated data inputs. Therefore, in addition to using feature filters to prefilter data prior to the automatic generation of signal rich models, the filters can be used directly to drive dynamic simulations of complex, adaptive systems.

The present invention further describes methods for constructing optimum combinations of filters to identify relevant data. The methods of the present invention allow optimum filter combinations to be represented as a composite database query. The resulting query can then be resolved by the query processing engine resident within the database to retrieve informative data to either the end user or for other analysis applications. The retrieved data is information rich against a user specified target feature, enabling the user to gain an “informative view” (or Info View) of the underlying database. This capability can significantly enhance the value of the database to the end user by isolating relevant data embedded within increasingly larger database environments. We note that the methods of the present invention can be applied across multiple databases with the info views from each database aggregated to present a composite view to the end user or application.

Finally, the present invention addresses the issue of filtering entire data records from further analysis. This is distinct from the well studied problem of feature selection in machine learning described for example by Bishop and in references contained therein where the goal is to reduce the dimensionality of a data set prior to modeling. Bishop, C. M., “Neural Networks for Pattern Recognition”, Oxford University Press, USA; 1 edition (1996) and references contained therein. In such a case, all the data records are maintained, but “irrelevant” features are removed across all the records. The present invention supports the application of feature selection methods on a data set which has been pre-filtered at the data record level in order to create the most “signal rich” data environment for modeling and analysis.

In summary, the methods of the present invention are based on a new approach to the removal of irrelevant data. The fundamental idea is based on the identification of informative “feature filters” that represent combinations of input features that preferentially filter data with respect to a specific target. Mutual information metrics are used to measure the information content of a feature filter with respect to a target feature. The feature filters inherently encode informative interactions between features through the inclusion of explicit ranges of values for each feature in multiple feature combinations that are evaluated concurrently. The present invention includes methods for automatically identifying multiple feature filters that exceed a mutual information threshold. The selected feature filters are then aggregated to form a composite filter set that is used to remove irrelevant data. The present invention further defines methods for identifying optimal values for the mutual information threshold to determine the optimum composite filter. For emphasis, we note again that no explicit classification of an individual data record with respect to a target state is performed during the filtering process. Rather, a data record is deemed to be irrelevant if its feature characteristics do no match those in the aggregated set of feature filters. The role of the target feature is therefore encoded in the information content of the filter, not in the specific target state of an individual data record.

The present invention also relates to methods for enabling a scalable transformation of diverse data of complex and complex, adaptive systems, as exemplified in the present invention with biological data, into hypotheses, models and dynamic simulations to drive the discovery of new knowledge.

In the present invention, data sets supporting complex and complex adaptive systems, including for biological systems data that span the “-Omics Continuum,” are analyzed to automatically identify useful and relevant data clusters against a set of (biological) objectives. The aggregate of data clusters forms a “signal rich” informative data set distilled from the -Omics Continuum through “Principled Data Management” that can be used to develop models and simulations, and to generate and test hypotheses.

The resulting hypotheses, models and simulations can then be used to further refine the identification of informative data sets to drive the generation of new hypotheses, models and simulations in an iterative fashion to converge to an optimal representation and modeling of complex and complex adaptive systems including biological systems. Finally, the models, model components, hypotheses, and the simulation can be compared with and validated against the known characteristics and behaviors of the biological system or against results from experiments that have been conducted in vitro, in vivo or ex-vivo.

Specifically, the present invention provides in a computer system, having one or more processors or virtual machines, each processor comprising at least one core, one or more memory units, one or more input devices and one or more output devices, optionally a network, and optionally shared memory supporting communication among the processors, a method for automatically identifying at least one informative data filter from a data set that can be used for identifying at least one relevant data subset against a target feature for subsequent hypothesis generation, model building and model testing resulting in more efficient data storage, data management and data utilization comprising the steps of:
(a) selecting at least one informative combination of interacting features from a data set from the one or more memory units using mutual information against the target feature as the selection criterion;
(b) identifying at least one state combination of each selected feature combination that defines an informative data filter, wherein the state combination has a mutual information score that exceeds a threshold mutual information and a data support level that exceeds a threshold data support;
(c) selecting an optimum intersection of the one or more informative data filters of step (b) for generating a data subset consisting of data records that share multiple common feature states for subsequent hypothesis generation model building, model testing against the target feature; and
(d) selecting an optimum union of the one or more informative data filters of step (b) for generating a data subset consisting of data records that have been aggregated across one or more data filters for subsequent hypothesis generation, model building and model testing against the target feature.

In another embodiment, the present invention teaches a method for the automatic identification of at least one informative data filter from a data set that can be used for driving a more computationally efficient and informative dynamic simulation comprising the steps of:
(a) selecting at least one informative combination of interacting features from a data set using mutual information against the target feature as the selection criterion;
(b) identifying at least one state combination of each selected feature combination that defines an informative data filter, wherein the state combination has a mutual information score that exceeds a threshold mutual information and a data support level that exceeds a threshold data support;
(c) associating a simulation entity with at least one informative data filter from step (b); and
(d) selecting a target state associated with the simulation entity stochastically at any point during the simulation using the probabilistic rule encoded by the mutual information score within each informative filter from step (c).

In yet another embodiment, the present invention provides a method of creating a computationally efficient, scalable, informative agent-based simulation system using automatically generated models or model components that encode informative emergent behavior of the system by automatically identifying at least one informative filter using the system of claim 1 and further comprising at least one of the steps of:
(a) developing models that support a simulation that encompasses informative emergent behavior by automatically identifying at least one informative filter and further using an approach selected from at least one of the group consisting of:
   i. automatically learning models from informative data;
   ii. automatically learning rules to guide the development of models;
   iii. automatically learning rules to guide combining models; and
   iv. modifying automatically learned models or rules to ‘tune’ models to support a simulation system; and
(b) developing a simulation system that encompasses emergent behavior that comprises at least one selected from the group consisting of:
   i. simulating a system at multiple scales;
   ii. simulating a system using multiple models; and
   iii. simulating a system using multiple modalities.

In another embodiment, the present invention teaches a simulation engine comprising a computer system, having one or more processors or virtual machines, each processor comprising at least one core, the system comprising one or more memory units, one or more input devices and one or more output devices, optionally a network, and optionally shared memory supporting communication among the processors for rapid simulation of complex or complex adaptive systems realized through the dynamic interaction of multiple models or modeling components capable of generating outputs suited to teaching, training, experimentation and decision support comprising:
(a) means for automatically learning models from informative data located on the one or more memory units; and
(b) means of developing a simulation system using a method that includes at least one selected from the group consisting of:
   i. simulating a system at multiple scales
   ii. simulating a system using multiple models
   iii. simulating a system using multiple modalities that enables at least one of:
      a. in silico experimentation and analysis of a complex system or a complex adaptive system;
      b. in virtuo experimentation and analysis of a complex system or a complex adaptive system; and
      c. in silico or in virtuo experimentation, analysis, modeling or representation of a biological system capable of being studied by at least one of the methods described as:
         i. in vitro;
         ii. in vivo; and
         iii. ex vivo.

The present invention also teaches a method of linking systems biology with data information using the above method.

In yet another embodiment, the present invention teaches in a computer system, having one or more processors or virtual machines, each processor comprising at least one core, one or more memory units, one or more input devices and one or more output devices, optionally a network, and optionally shared memory supporting communication among the processors, a method of increasing manufacturing yield using at least one informative data filter, wherein the informative data filter is at least one manufacturing parameter;
the method comprising automatically identifying at least one informative data filter from a data set for identifying at least one relevant data subset against a target feature for subsequent hypothesis generation, model building and model testing that can result in more efficient use of materials comprising the steps of:
   (a) selecting at least one informative combination of interacting features from a data set from the one or more memory units using mutual information against the target feature as the selection criterion;
   (b) identifying at least one state combination of each selected feature combination that defines an informative data filter, wherein the state combination has a mutual information score that exceeds a threshold mutual information and a data support level that exceeds a threshold data support;
   (c) selecting an optimum intersection of the one or more informative data filters of step (b) for generating a data subset consisting of data records that share multiple common feature states for subsequent hypothesis generation model building, model testing against the target feature; and
   (d) selecting an optimum union of the one or more informative data filters of step (b) for generating a data subset consisting of data records that have been aggregated across one or more data filters for subsequent hypothesis generation, model building and model testing against the target feature.

Finally, the present invention teaches in a computer system, having one or more processors or virtual machines, each processor comprising at least one core, one or more memory units, one or more input devices and one or more output devices, optionally a network, and optionally shared memory supporting communication among the processors, a method of improving healthcare diagnosis and treatment using at least one informative data filter, wherein the informative data filter is at least one health statistic; the method comprising automatically identifying of at least one informative data filter from a data set for identifying at least one relevant data subset against a target feature for subsequent hypothesis generation, model building and model testing comprising the steps of:
(a) selecting at least one informative combination of interacting features from a data set from the one or more memory units using mutual information against the target feature as the selection criterion;
(b) identifying at least one state combination of each selected feature combination that defines an informative data filter, wherein the state combination has a mutual information score that exceeds a threshold mutual information and a data support level that exceeds a threshold data support;
(c) selecting an optimum intersection of the one or more informative data filters of step (b) for generating a data subset consisting of data records that share multiple common feature states for subsequent hypothesis generation model building, model testing against the target feature; and
(d) selecting an optimum union of the one or more informative data filters of step (b) for generating a data subset consisting of data records that have been aggregated across one or more data filters for subsequent hypothesis generation, model building and model testing against the target feature.

### BRIEF DESCRIPTION OF THE DRAWINGS

FIG. 1 illustrates the aggregation of multiple signal rich local data clusters to form a larger relevant data subset.

FIG. 2 illustrates the intersection of multiple signal rich data clusters to identify an informative data subset that shares multiple common traits.

FIG. 3 illustrates providing “InfoViews” into database environments.

FIG. 4 shows a traditional feature selection approach to noise reduction.

FIG. 5 exemplifies the noise filtering approach of the present invention.

FIG. 6 shows mutual information and data support profiles of aggregate training subsets from Table 1.

FIG. 7 shows a data support profile for test data subset as a function of filter mutual information threshold.

FIG. 8 shows accuracy profiles on test signal data for both target states (“Absent” and “Present”) as a function of filter mutual information threshold.

FIG. 9 illustrates accuracy profiles on test noise data for both target states (“Absent” and “Present”) as a function of filter mutual information threshold.

FIG. 10 illustrates the Boman Model for the proliferative kinetics of normal and malignant tissues.

FIG. 11 illustrates the Johnston Model.

FIG. 12 shows a generalized ABM framework for a multiscale simulation of colorectal cancer.

FIG. 13 illustrates example cell behaviors for colorectal cancer model.

FIG. 14 shows specific transformations for cell types and functions in colorectal cancer simulation (From Boman, et al 2007).

### DETAILED DESCRIPTION OF THE INVENTION

The underlying premise of the present invention is based on the observation that the key emergent properties of a complex (or complex adaptive) system can be captured by modeling agent behaviors with the most informative statistical associations rather than by modeling the entire data environment.

With regard to the development of the models and model components the present invention describes methods, and an initial implementation, for efficiently linking relevant data both within and across multiple domains and identifying informative statistical relationships across this data that can be integrated into agent-based models. The relationships, encoded by the agents, can then drive emergent behavior across the global system that is described in the integrated data environment.

An important advantage of the present invention lies in the significant reduction in complexity and the resultant computational efficiency in generating models and modeling components that results from identifying the most informative statistical relationships across large and ever increasingly complex data environments including those related to biology and other complex and complex adaptive systems.

With regard to the development of the models and model components the present invention describes methods, and an initial implementation, for efficiently linking relevant data both within and across multiple domains and identifying informative statistical relationships across this data that can be integrated into agent-based models. The relationships, encoded by the agents, can then drive emergent behavior across the global system that is described in the integrated data environment.

This approach can be contrasted with existing approaches that model each domain with significant detail, and subsequently link the domain models into a hierarchical manner to represent the global system. The underlying premise of the present invention is based on the observation that the key emergent properties of a complex (or complex adaptive) system can be captured by modeling agent behaviors with the most informative statistical associations rather than by modeling the entire data environment.

Viewed from the perspective of signal processing the present approach describes methods to identify the ‘signal’ within the data and to filter out the ‘noise’. In many complex data systems the noise dominates the signal, making unfiltered models significantly less efficient in representing the underlying—sometimes weak—signal.

The present invention discloses methods associated with data analysis and knowledge discovery that allow a user to:
i. Automatically discover relevant, information rich data subsets from a larger data set that can provide insight into the problem being studied, as well as form the basis for subsequent hypothesis generation, analysis, modeling and simulation.
ii. Automatically generate a population of signal models from informative data subsets for predictive analytics and hypothesis generation/testing.
iii. Create a computationally efficient, scalable, informative, agent-based simulation system using the automatically generated models or model components that encode the informative emergent behavior of the system.
iv. Generate a simulation system that encompasses emergent behavior that comprises the simulation of a system at multiple scales, using multiple models, and including multiple modalities.
v. Perform in silico or in virtuo experimentation, analysis, modeling or representation of a complex or complex adaptive system that in the present invention which exemplifies the invention as a biological system would be capable of being studied by at least one of the methods described as in vitro, in vivo or ex vivo.

### Identification of Relevant Data:

Traditionally, in the progression of data to information to knowledge, the role of data, though essential, has represented an early “pit stop” on the way towards knowledge discovery. Data is typically analyzed to identify important features of the data that can then be used to develop informative models or model components. A well constructed model represents a compact description of the underlying data, and can be used to represent the data in the knowledge discovery process.

As the volume of data has increased over recent years, the amount of data has posed significant bottlenecks across the entire chain represented by the progression of data to information to knowledge. Data management has become increasingly complex and expensive, and the subsequent analysis of the data has suffered as well. In addition, the ability for humans to interpret the data in order to form testable theories or hypotheses becomes more difficult when confronted with vast amounts of data.

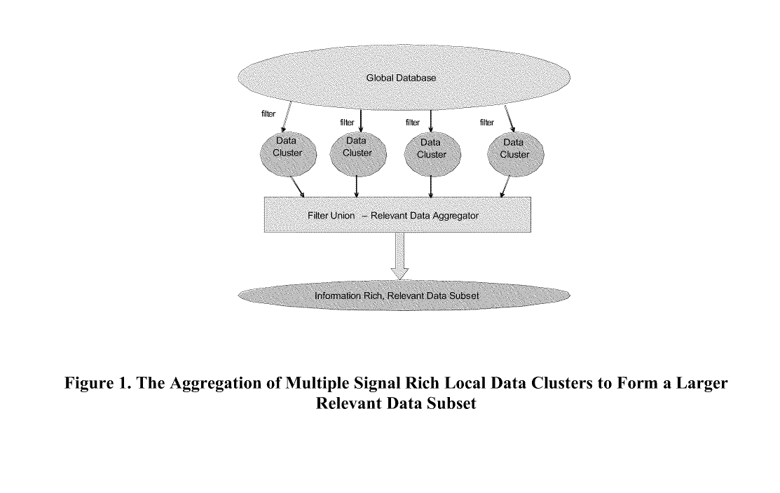

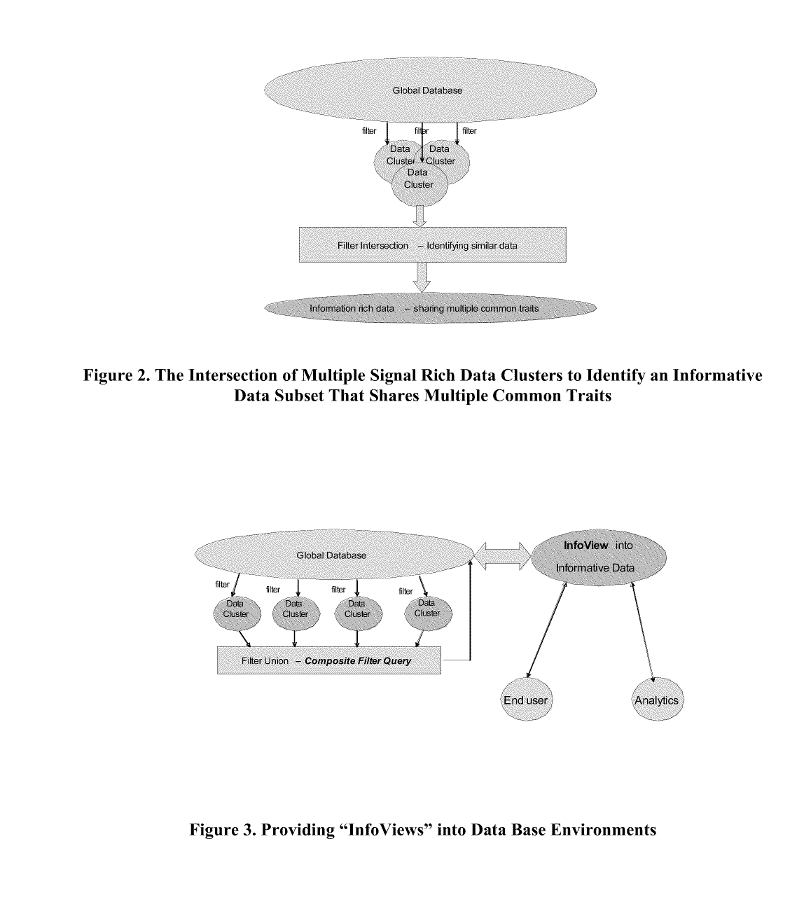

The methods of the present invention offer unique capabilities in identifying relevant subsets of data that may be embedded in large data environments. Based on the principle of building data management and analysis capabilities in a modular, progressive fashion, subsets of data that result from relatively simple informative and relevant “clusters” that are automatically identified are combined in several ways to provide the basis for subsequent modeling and analysis as well as to obtain insight. Individual data clusters can be combined optimally via both union and intersection operations using optimization techniques. An optimal union of clusters can facilitate the generation of larger, “relevant” clusters that are informative and less noisy for subsequent model building (FIG. 1). An optimal intersection of clusters can reveal more specific sub-clusters that can isolate and present interesting subsets of data to the user for analysis and understanding (FIG. 2).

It should be noted that relevance is measured with respect to a specific target or question. A particular data set can have high relevance to one target but low relevance to another. In the method of the present invention, informational metrics are used to measure the relevance of a data set to a target, and automated methods (through the union and intersection operations mentioned above) have been developed to generate high relevance data subsets from larger data sets.

### Identification of an Optimal Union of Data Clusters:

An optimal union of multiple signal rich data clusters is identified using the following methodology:
a. An interval of mutual information thresholds for data clusters ranging from a minimum mutual information threshold to a maximum mutual information threshold is defined. Note that each cluster is derived from a corresponding “data filter” that represents a combination of input features where each feature is in a specific state.
b. For each mutual information threshold, a set of data filters is automatically identified where the mutual information of the underlying data cluster exceeds the threshold, and where the data support for the cluster exceeds a minimum data support level. The filters can be identified either by exhaustive searching or by other searching techniques such as genetic algorithms.
c. An aggregate data set resulting from the merging of all the data clusters from step (b) is then assessed for mutual information against the target feature, using the mutual information metric:

$$I ( X ; Y ) = {\sum }_{y ∈ Y} {\sum }_{x ∈ X} p ( x , y ) log ( \frac{p ( x , y )}{{p}_{1} ( x ) {p}_{2} ( y )} ) ,$$

where p(x,y) is the joint probability distribution function of X and Y, and p₁(x) and p₂(y) are the marginal probability distribution functions of X and Y respectively. Here, X represents an input feature, and Y represents the target feature. Note that the merging of the individual data clusters can also be expressed in terms of the union of the corresponding data filters.
d. As the mutual information threshold is increased from its minimum value, the mutual information profile for each corresponding aggregate data set is analyzed to identify the threshold value where there is both a sharp increase in the mutual information of the aggregate data as well as a sharp decrease in the level of data support. The degree of sharpness in the discontinuity is controlled by the user. The filter union and corresponding data aggregate at this point of discontinuity defines the “signal rich” data useful for further study.

### Identification of an Optimal Intersection of Data Clusters:

An optimal intersection of multiple signal rich data clusters is identified using the following methodology:
a. A set of information rich input feature combinations against a target feature is automatically identified from the data. This identification can be enabled by either exhaustively searching the input feature space or by using other searching techniques such as genetic algorithms. Note that each selected feature combination consists of multiple data filters where each filter represents a unique set of feature states associated with the combination.
b. Defining a fitness function that comprises both a data support term and a feature complexity term across one or more intersecting data filters:

fitness function=λ*data support−(1−λ)/(feature complexity)
where λ is a normalized tuning parameter between 0 and 1 that adjusts the relative weighting of data support versus feature complexity.
c. Searching the space of informative data filters across each feature combination in step (a) for a combination of intersecting data filters that maximizes the fitness function of step (b).

For example, if λ is set to 1, data support becomes the dominant factor controlling fitness, and a single filter that provides maximum data support will be selected. Conversely, if λ is set to 0, feature complexity as defined by the number of features participating in the intersecting filter set becomes the dominant factor. In this instance, a maximal number of filters will be selected, regardless of the resulting data support. For intermediate values of λ, a pool of “hybrid” filter intersections can be identified that balance the weighting of data support with that of feature complexity. The end result is a set of intersecting data records that share multiple common feature states.

The underlying premise around data relevance is that more informative “signal” models can be built from high relevance data sets. In effect, much of the noise in the data has been filtered out, leaving an information rich data “kernel” that can be explored and modeled. New test data coming in can be assessed by the relevance filter with the data that passes the relevance test representing signal that can effectively be modeled. Thus, noise can be filtered out of the system both during model building as well as model usage. The ability to automatically separate data that represents “signal” from data that represents “noise” during both model building and model usage is an important differentiating capability of the present invention. Typically, this separation does not occur in data management/analysis systems, or the separation is based on a predefined noise model that is imposed on the data. The ability to automatically separate out noise data from signal data can have important consequences in subsequent decision making; for example, ignoring predictions from irrelevant data and only acting upon predictions from relevant data can improve the overall effectiveness of decision making.

The capability of automatically aggregating relevant data across one or more databases to provide an informational view (Info View) into the data environment is an important differentiating capability of the present invention. Traditional data views within a database environment result from associations made only at the data level. Using informational metrics to guide the automatic generation of informative data views that can be processed by both human end users as well as other analytic/data processing tools provides a basis for transforming data warehouses into information warehouses. This capability has significant implications in driving an effective and scalable transition from data to information to knowledge. Analysis engines can use less data that is more relevant to the target at hand to build more accurate signal models that can be used to generate and test hypotheses, make predictions and gain insight. In a data environment that is continuing to expand rapidly, this capability will become increasingly important.

The intersection of data records over multiple data clusters represents a powerful way to present interesting data to the user to gain insight as well as facilitate hypothesis generation. Data that share multiple common feature traits, extracted from a much larger database, can provide insight into interactions that are informative against a particular target. The methods of the present invention automatically generate such interesting data to the end user and/or other analysis and visualization applications.

An interesting example of the identification of intersecting data records within a large database presents itself in the area of combinatorial chemistry. Chemical compounds are often described by the presence or absence of chemical substructures. Discovering compounds that share multiple structural features that map to biochemical activity can provide a useful guide to elucidation of activity mechanisms as well as guide synthetic drug design. In addition, using the intersection of data records over multiple low dimensional data clusters to identify high dimensional commonalities can be significantly more efficient than directly searching across a high dimensional space.

Note: An end user can drive the automatic generation of composite filter query to retrieve data that is relevant against a user defined target. The retrieved data can be used by both the end user and/or analytic tools for hypothesis generation and model building.

FIG. 3 outlines the coupling of a relevance filter into a database environment to provide “Info-Views” around data relevant to a specific target or set of targets. An end user can define a target (or targets) of interest and the methods of the present invention can be used to automatically generate a composite filter query to drive the retrieval of relevant data into an “Info-View”. We note that both the union and intersection operations that are applied to the database can be expressed in the language of database filtering. The union operation represents a logical OR-ing of several individual filters that define the informational clusters and the intersection operation represents a logical AND-ing of several individual filters. Thus, existing methods for resolving database queries can be applied seamlessly to the relevance filter of the present invention in order to present informative data views to the end user or analysis application. This helps address some important issues around scalability, as the relevance filter can be implemented as a thin layer on top of existing database systems and leverage already existing and optimized methods for generating data views in large data environments. Distributing the filtering capability across multiple data subsets spanning the database can further improve scalability by generating multiple, smaller informative data views that could provide the basis for distributed modeling. Finally, we note that the database environment could represent more than one database as the process outlined above could be executed simultaneously across multiple databases, with each separate Info-View being merged into a final composite Info-View.

Automatic Building of Signal Models from Relevant Data Subset:

The methods of the present invention also provide for the capability of automatically generating one or more signal models from informative data subsets for predictive analytics and hypothesis generation/testing. It should be noted that any empirical modeling technique that can model a global data set can also be used to model an informative data subset that has been automatically identified from the global data. Examples of modeling techniques include decision trees, neural networks, Bayesian network modeling, and a variety of both linear and non-linear regression techniques. Using the methods of the present invention to first identify relevant data subsets from which populations of models are then automatically generated, can result in improved signal models that are modeling the information embedded in the data rather than the noise. Traditional modeling paradigms generally do not automatically separate signal from noise at the data record level during the process of building models; rather, variables are preferentially selected that tend to be more informative across the entire data set. Feature selection that occurs as part of model building is thus a primary means for noise removal in current modeling approaches. In the methods of the present invention, there is both data record filtering as well as feature filtering to reduce the noise in the data environment for a particular modeling application. The data record filtering using automatically generated relevance filters presents a key differentiator between the current invention and other data management/analysis systems.

Note: First, the number of records is reduced, followed by feature filtering on the reduced database.

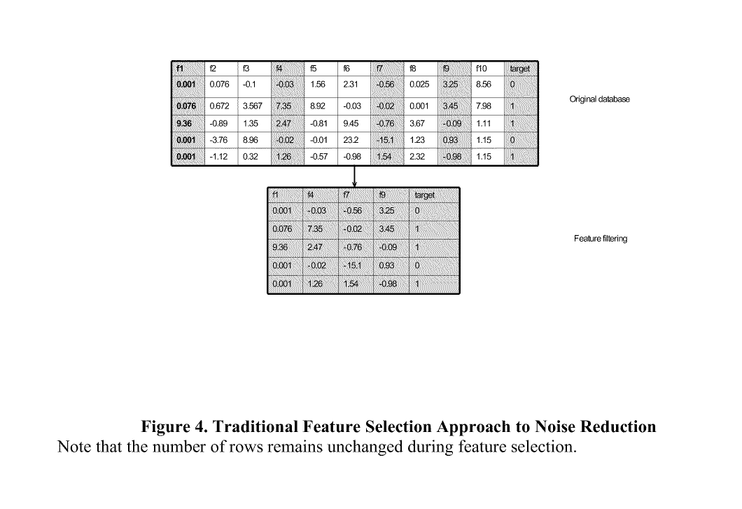

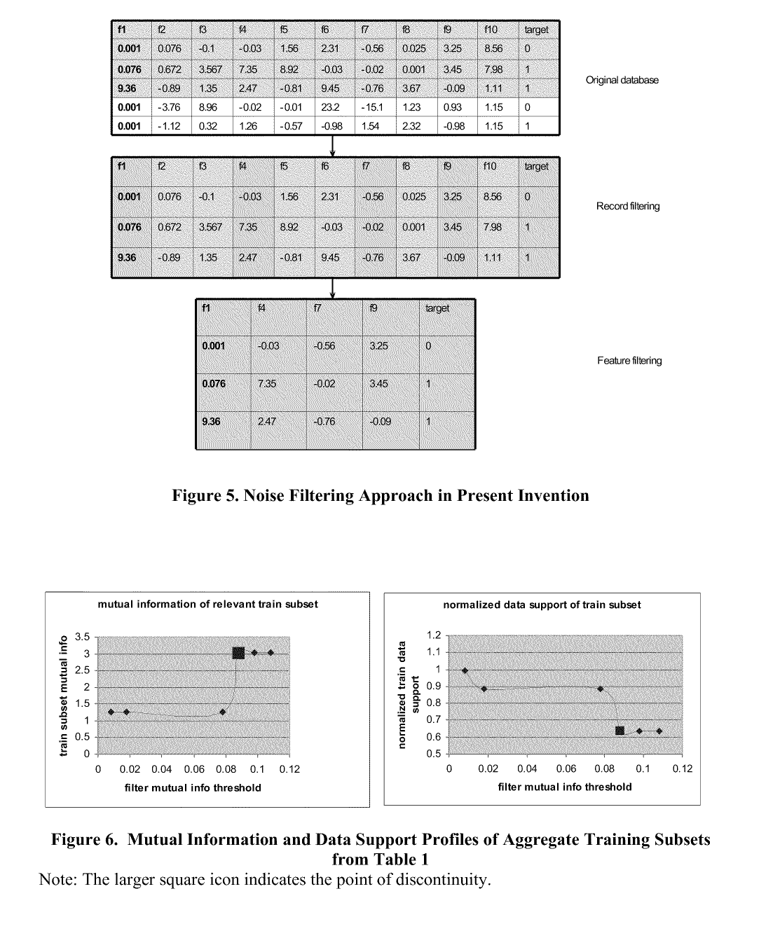

FIGS. 4 and 5 compare traditional noise filtering against noise filtering as described in the present invention. In FIG. 4, the number of columns, or features, is reduced during the feature selection sub step of model building. Note that the number of rows, or data records, is preserved during feature selection. In FIG. 5, the first step involves reducing the number of data records by removing irrelevant records that do not satisfy the rules described by the composite filter union. Traditional feature selection methods can then be applied as a second step on the reduced data set. The application of both noise reduction steps in the present invention can result in the generation of superior hypotheses and predictive models as will be demonstrated in the example below.

### Using Informative Filters to Drive Dynamic Simulations:

The informative filters and filter combinations described in the present invention can be used to define informative rules that can drive dynamic simulations. Agent based modeling is a modeling paradigm that is particularly well suited to this approach, where the behavior of individual agents, representing modeling entities, can be driven stochastically by the probabilistic rules embedded in the filters associated with the agents. Such a modeling paradigm, driven by rules that are learned directly from the data, can result in emergent behavior of the global modeling environment that is well matched to observations.

Informative Filters can also be used to identify a group of modeling components that are mutually informative or that together are informative against a specific target or targets. Identifying subsets of “signal rich and noise poor” informative modeling components within a large data environment can reduce the complexity of subsequent models and simulations without suffering a significant loss in modeling fidelity.

Alternatively, the simulations can generate new data during a simulation run that can in turn be assessed by the filters to modify the subsequent dynamics of the simulation. If the simulation is coupled to an external dynamic data source, changes in the external data can further modify simulation dynamics.

### SUMMARY

For completeness, key differentiators between the methods described in the present invention and prior art include:

Automatic identification of informative and relevant data subsets using mutual information measures for subsequent model building and system understanding. This is enabled through the discovery of multiple informative clusters that are then combined through either union or intersection operations.

Leveraging the identification of relevant data subsets into a mechanism for providing Info Views into large databases above and beyond more traditional data views. This capability, implemented through existing database filtering operations, can transform data warehouses into information warehouses. We note that the larger database could represent a virtual database comprised of one or more distinct databases.

The ability to develop more accurate signal models by modeling on less noisy, relevant data subsets rather than the entire data space. Related to this is the ability to automatically separate signal from noise during model building and model usage through both feature filtering as well as data record filtering. Again, we emphasize that different existing modeling paradigms can be used to generate the signal models on the relevant data.

The capability for developing more scalable analytics by modeling on relevant data subsets rather than the entire data space

The ability to use the probabilistic rules embedded in the filters, learned directly from the data, to drive dynamic simulations.

### Modeling & Simulation Using Informative Data.

The present invention addresses the problems that are emerging from analysis of complex and complex adaptive systems where the data environment is large, complex and expanding as new technologies are applied that facilitate reductionist analysis and which generate additional information about the system components.

This is exemplified by considering biological systems where the application of analytical techniques in the field of molecular biology have led to a massive increase in the available data describing the system and system components. In this case examples that are widely discussed include the data from genomic analysis (including especially the Human Genome Project) and ongoing related efforts, proteomic analysis and more broadly the other areas of biological analysis that can be described as the -Omics Continuum. Review of the current published literature in this field frequently cite the problems with the amount of data that is available for analysis, the inevitable increases in the amount of data that further analysis will bring and that are inherent in the reductionist approach to biology.

In biological sciences one of the first approaches that has been applied to the study of the components is ‘systems biology’ a biology-based inter-disciplinary study field that focuses on the systematic study of complex interactions in biological systems, thus using a new perspective or paradigm (integration instead of reduction) to study them.

In the context of the present invention we can consider systems biology as a paradigm that is fully consistent with the scientific method and the antithesis of reductionism. The distinction between the two paradigms is referred to in these quotations:

The reductionist approach has successfully identified most of the components and many of the interactions but, unfortunately, offers no convincing concepts or methods to understand how system properties emerge . . . the pluralism of causes and effects in biological networks is better addressed by observing, through quantitative measures, multiple components simultaneously and by rigorous data integration with mathematical models.” Sauer, U. et al., “Getting Closer to the Whole Picture,” Science 316: 550 (27 Apr. 2007).

Systems biology . . . is about putting together rather than taking apart, integration rather than reduction. It requires that we develop ways of thinking about integration that are as rigorous as our reductionist programmes, but different . . . . It means changing our philosophy, in the full sense of the term”. Denis Noble, The Music of Life: Biology beyond the genome, Oxford University Press. ISBN 978-0199295739 (page 21) (2006).

The initial attempts by researchers to use the data from systems biology to re-create the multiple biological networks that would provide the basis for building model components, models and simulations have demonstrated how difficult a task it is to account for the complexity of the system and the lack of complete data.

In addition to their size and complexity the datasets and networks that describe biological systems are further complicated by the wide range of temporal and spatial scales that the network model components and models operate over and that will need to be linked in any meaningful simulation. This is another novel feature that the present invention addresses.

To address some of limitations previously noted concerning the creation of networks one of the approaches that has been initially applied in systems biology involves the use of large scale perturbation methods; included in this approach are the prior art cited below. These technologies are still emerging and many face problems that the larger the quantity of data produced, the lower the quality. A key facet of the present invention is a novel method and solution to this emergent problem.

The present invention provides a novel method for addressing the problems that are inherent in using the datasets derived from the reductionist approach to analysis of biological systems. By providing for automatic data filtering and building of model components and models and linking these using principled methods to generate hypothetical components for simulations that can be validated using expert inputs and established experimentation the proposed invention will provide a unique capability to address the development of analytical environments for complex and complex adaptive systems including as described in the present invention biological systems.

### EXAMPLES OF THE PRESENT INVENTION

### Example 1

### Data Filtering & Identification of Relevant Data from the AERS Data Base and Building Signal Models from that Data

### Motivation:

The methods of the present invention describe principled means by which “signal-rich” data subsets can be automatically identified within a large and potentially noisy data environment. The use of general mutual information metrics to drive the identification of the subsets has the advantage of being “agnostic” to the type and character of the underlying data. In particular, these metrics do not assume an a priori distribution of states within the data environment, but are inherently adaptive to the prevailing data statistics. It is the generality of the approach that makes the methods of the present invention suitable to improve the quality of any data driven model or simulation by fundamentally improving the signal to noise ratio of the data that is used.

In order to demonstrate the generality of the methods of the present invention, we present an example centered around an area of current interest within the health care domain. The example is based on data collected by the FDA around adverse reactions exhibited by patients under different combinations of symptoms and medications. The specific characteristics of the data are detailed below; at a more general level, the data represented by this example exhibits several attributes that make it attractive as a candidate for demonstrating the methods of the present invention: The data sets are noisy and incomplete, with relatively low statistics of adverse events to normal events characteristic of a “needle in a haystack” type problem. As such, models that are built directly off the raw, unfiltered data can suffer in performance due to the incorporation of significant amounts of noise. Comparing predictive models around adverse events that are built using only the “relevant” data with models that are built using unfiltered data thus provides a useful validation of the methods described in the present invention.

The following sections provide more background on the data characteristics of the Adverse Event Reporting System, followed by results of data filtering and a comparison of “relevant” model performance with “unfiltered” model performance on a test data set.

It is important to reemphasize that the methods of the present invention are generally applicable across data environments that exhibit some or all of the attributes outlined above, and can thus be used advantageously to provide informative data for subsequent modeling and simulation. In the context of agent based modeling of biological systems, the methods of the present invention can be used to “simplify” the modeling environment by identifying only the most informative or relevant modeling components required to build a modeling environment of high fidelity. In addition, they can be used to directly infer the most informative probabilistic rules supported by the data that drive the behaviors of individual agents resulting in the emergence of global behaviors of the entire system.

### Background

As summarized in http://www.fda.gov/cder/aers/default.htm:

The Adverse Event Reporting System (AERS) is a computerized information database designed to support the FDA's post-marketing safety surveillance program for all approved drug and therapeutic biologic products. The FDA uses AERS to monitor for new adverse events and medication errors that might occur with these marketed products . . . . AERS is a useful tool for FDA, which uses it for activities such as looking for new safety concerns that might be related to a marketed product, evaluating a manufacturer's compliance to reporting regulations and responding to outside requests for information. The reports in AERS are evaluated by clinical reviewers in the Center for Drug Evaluation and Research (CDER) and the Center for Biologics Evaluation and Research (CBER) to monitor the safety of products after they are approved by FDA.”

The AERS data is updated in quarterly installments of multiple data files. In this example, we collected demographic, drug usage and reactions files from the fourth quarter of 2005 through the third quarter of 2007. The demographic file contains patient information and administrative information about the case. The drug usage file lists for each case every medicine that was involved in the case along with the drug's reported role in the event (either Primary Suspect, Secondary Suspect, Concomitant, or Interacting). The reactions file lists all adverse reactions that the patient experienced in the case. The cases are linked between files by a unique encrypted identifier.

In our experimental design we used the concept of a “seed drug”. There were 93,386 unique drugs mentioned during the period of study. We first sub selected 148 drugs that were involved in over 2,500 cases. We then selected Aspirin as our seed drug and applied the following process to create our input database:
1. Choose Aspirin as the seed drug.
2. In the cases that Aspirin was involved in, identify the other drugs that were also involved in these cases, and select the 20 other drugs that had the highest co-occurrence with Aspirin.
3. Identify all cases that Aspirin and its top 20 co-occurring drugs are involved in.
4. Count the number of times that a given reaction occurred in each of these cases, and then choose the 25 reactions that occurred most often.
5. Narrow the list of cases to include only those that had at least one of the top 25 reactions. For Aspirin, this resulted in 94,962 cases.
6. Finally, we collect the demographic information for each of these selected cases from the demographic file. For this experiment, we collected gender, weight (which we normalized to pounds), and age (which we normalized to years).

Note: One issue that arises with the demographic information is that some of the data is missing. We included the rest of the data and labeled the missing information in our final data table as missing.

### Results:

In this example, cardiovascular disorder is defined as the target variable and a total of 48 features spanning demographic, drug usage and symptom attributes comprise the inputs. Cardiovascular disorder was present in 5.8% of the training data. A total of 10,038 records were used for identifying to generate a series of filter unions at several filter information thresholds using the method of the present invention. The data aggregates resulting from each filter union were used to build a series of “signal” Bayesian network models using the open source Weka machine learning library. Residual “noise” models were built at each corresponding filter information threshold using training data that did not form part of the aggregate. Finally, a “baseline” model using all the training data was built as a reference.

In order to compare the models, 9,915 records were used for testing the filter union. Cardiovascular disorder was present in 5.9% of the test data. At each filter information threshold, the test data was filtered using the same filter union that was identified during training. The test data that passed through the filter union, or the test signal, was evaluated using the corresponding signal model. The residual test data, or the test noise, was evaluated using the corresponding noise model and the entire test data set was finally evaluated using the baseline model.

TABLE 1
Mutual Information and Data Support Profiles of Aggregate Training
Data Set Versus Mutual Information Threshold

| Mutual Information | | |
|---|---|---|
| Filter | Mutual Information of Relevant | Relevant |
| Threshold | Training Data Subset | Training Data % |
| 0.008 | 1.254193693 | 0.995616657 |
| 0.018 | 1.254193693 | 0.88573421 |
| 0.078 | 1.254193693 | 0.88573421 |
| 0.088 | 3.041552207 | 0.638174935 |
| 0.098 | 3.041552207 | 0.638174935 |
| 0.108 | 3.041552207 | 0.638174935 |

Table 1 and FIG. 6 show both the mutual information and data support profiles for the aggregate training data subset as a function of the mutual information threshold for the filters. As the threshold increases, there is a sharp increase in the mutual information of the aggregate data set at a threshold of ˜0.08. At this same threshold value, there is a corresponding decrease in the data support of the aggregate data set. The point of discontinuity corresponds with the removal of “irrelevant” data or noise from the data system, where relevance is measured with respect to the target feature, which in this case represents cardiovascular disorder. Note that if the target feature were changed for example to “anxiety”, then the aggregate data set at the optimal point of discontinuity would represent a different data subset than that generated using cardiovascular disorder as the target. Relevance is always measured in the context of the question being asked.

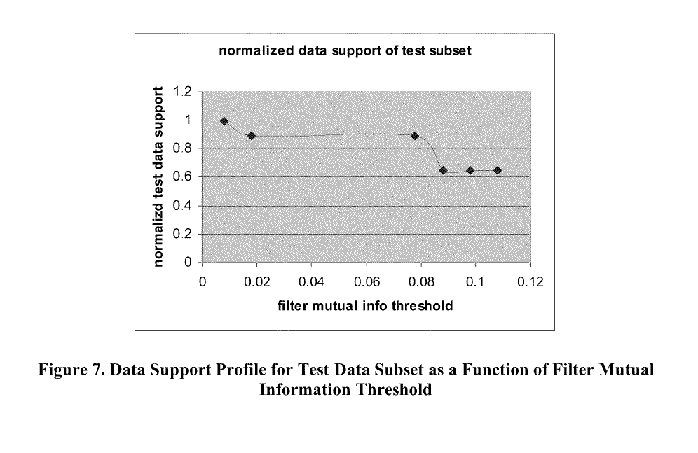

FIG. 7 shows the data support profile for the test data subsets that were generated using the corresponding filter unions derived from the training data. Note that this profile is very similar to the profile generated for the training data subset, indicating that the filters are robust and generalize well.

### Results of Modeling on the Test Set:

### Bayesian Signal Models Using Weka:

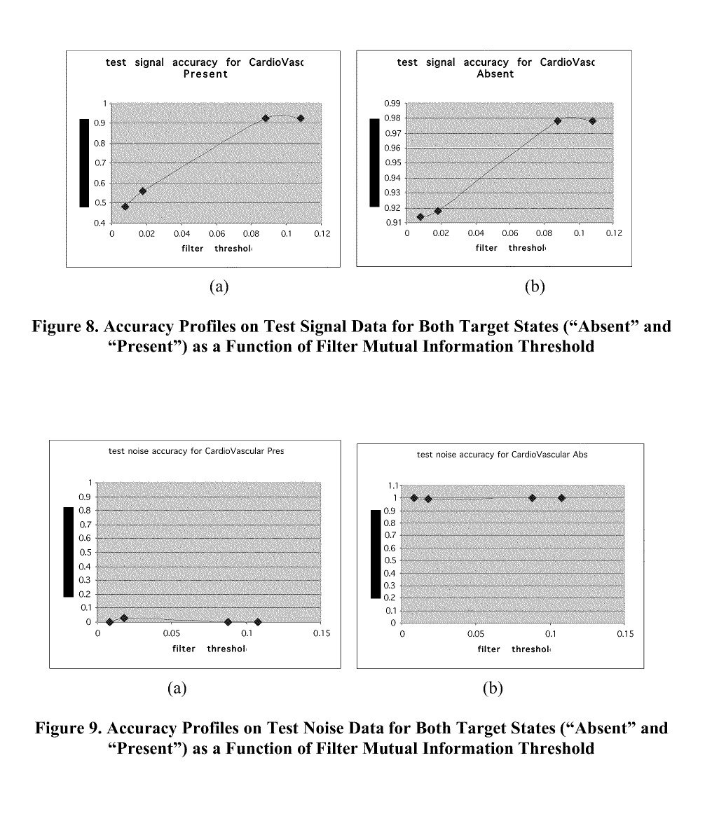

FIG. 8 plots the accuracy profile for each cardiovascular state (“absent” and “present”) in the filtered test data set as a function of filter threshold. As noted earlier, the cardiovascular “present” state is supported by 5.9% of the test data. In FIG. 8 (a), at the point of discontinuity, coinciding with a filter threshold of ˜0.08, the filtered test set accuracy for the minority target “present” state has jumped up to >90% from an initial value of <50%. At the same threshold value, FIG. 8(b) shows that the filtered test set accuracy for the majority target “absent” state has increased to >97% from an initial value of ˜91%. This supports the hypothesis that building signal models using filtered training data can result in superior out of sample performance when the test data is filtered similarly. “Triaging” the data both during model building and model usage to ignore irrelevant data can be preferable to modeling with noise and predicting with noise. In the latter case of predictions, retrospectively assessing why a noisy prediction failed may be significantly more expensive than not making the prediction in the first place.

### Bayesian Noise Models Using Weka:

FIG. 9 plots the accuracy profile for each cardiovascular state (“absent” and “present”) in the residual, “irrelevant” test data set as a function of filter threshold. Note that in this case, the noise models derived from the residual training data were used at each corresponding filter information threshold to evaluate the residual test data. FIG. 9(a) shows the “present” state accuracy of the noise models to be ˜0%. FIG. 9(b) shows the “absent” state accuracy of the noise models to be ˜100%. This indicates that the noise models have not learned much about the target states and have defaulted to predictions solely based on the dominant target state. This is consistent with the observation that the residual data sets are information poor, with the signal models retaining most of the information in the data system. We note that at the point of discontinuity, ˜35% of the data has been filtered out of the system in both the training and test sets. This provides an additional benefit in building more compact models using less data that are also superior in performance.

### Baseline Bayesian Model Using Weka:

The baseline Bayesian Model built using all the training data resulted in an accuracy of 91.5% for the entire test data in the “absent” state, and an accuracy of 48.3% for the entire test data in the “present” state. Note that these results are consistent with the low threshold accuracies in FIGS. 8(a) and 8(b). The results from the signal, noise and baseline models thus provide strong empirical support for the methods described in the present invention.

### Other Applications:

The methods of the present invention can be applied quite generally across many application domains. For example, in the domain of health and life sciences, there is a proliferation in data that spans multiple disciplines relating to a common target feature such as a specific disease condition. The methods of the present invention can be used to generate relevant data subsets from the large volume of data that connects multiple inputs in an informative manner to facilitate hypothesis generation and model building in a computationally efficient manner. Another example is in financial forecasting where the data sets are very noisy. In this domain, the capability of “triaging” the data to separate relevant data from irrelevant data can be very valuable in reducing the possibility of making erroneous predictions. In addition, the methods of the present invention can be useful in guiding “principled data management” where only data relevant to a particular question or set of questions need to be managed, thus potentially reducing storage requirements and facilitating database management and analysis. For large volume data environments, reducing the amount of data under storage can provide significant cost advantages as well.

### Example 2

### Use of Multi-Scale Models to Develop Simulations of a Biological System

### Multiscale Modeling of Colon Cancer

Colon cancer is one of the best characterized cancers with many models being published that include highly disparate datasets that can be translated into networks that operate over multiple scales to describe how the disease originates and develops in humans and animal models. Several attempts have been made to develop mathematical models of the disease to integrate and try and make sense of the biological information being generated and generate new hypotheses that can then be tested in the laboratory.

In order to understand the ways in which subcellular (microscopic) events influence macroscopic tumor progression it is necessary to develop models that incorporate multiple temporal and spatial scales. Moreover, there are many discrete models that describe specific aspects of colon cancer and the issues that link normal tissue to colorectal cancer. Finally, the substantial increase in the capability to analyze the biological system that describes colon cancer—in patients or in suitable experimental models—is generating large datasets that might inform an understanding of the system but for which only very limited capability exists in terms of analysis, modeling and system simulation. The present invention addresses these concerns and provides a novel technology framework and capability to enable a scalable transformation of diverse data, exemplified with biological data into hypotheses, models and dynamic simulations to drive the discovery of new knowledge about the biology of colon cancer oncogenesis.

In this example the present invention will be applied to two models of the underlying mechanisms that lead to colorectal cancer. The two models operate at different scales thus demonstrating the value of the present invention to provide a framework for incorporation of multiscale models and model components.

### Mathematical Modeling for Colon Cancer

Over the past few years, mathematical modeling for colon cancer has made significant progress and now represents an important area of research into carcinogenesis, disease progression and possible targets for treatment. Several groups have developed differential equation based approaches to modeling the cell population dynamics in a crypt resulting in a novel basis for developing hypotheses around mechanisms of cell migration and differentiation as well as tumor development (see, for example, references [1][2][3]).

In the present invention the ‘Gryphon®’ software represents a system that is capable of performing scalable and computationally efficient and rapid simulation of complex or complex adaptive systems realized through the dynamic interaction of multiple modeling components to generate outputs suited to decision support, analysis and planning.

Implementing the colon cancer models noted above within the Gryphon® environment can enable powerful dynamic visualization of cell population dynamics, provide an ability to perform multiple simulation runs under different initialization conditions, and the ability to “pause” a simulation mid stream and adjust parameters before restarting the simulation. The latter feature will support high fidelity modeling of the development of the disease and its progression in the crypt.

In order to demonstrate the features of the present invention a brief description of the two models that can be integrated within the Gryphon® environment are outlined. The two models that are used in this example are:
1. The deterministic model of Boman et at [1]
2. The deterministic model of Johnston et at [2].

### Deterministic Modeling of Cell Population Dynamics by Boman et al:

Boman's (2007) model assumes that there are four types of cell populations in a crypt: stem cells (SC), intermediate cells (IC), non-proliferative cells (NC) and eradicated cells (EC).

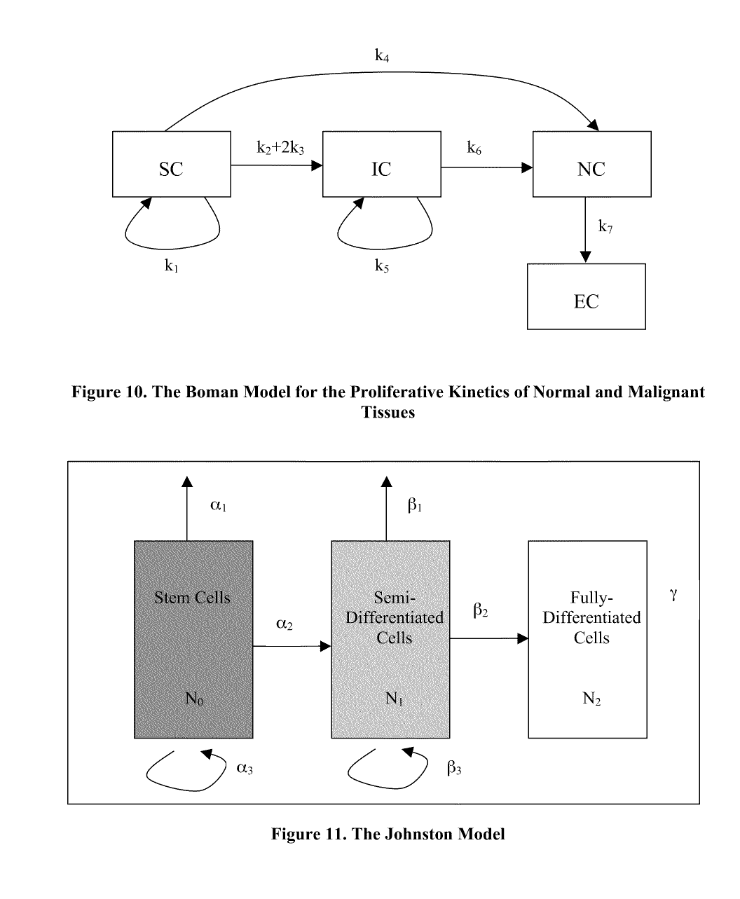

The Boman model describes the dynamics of these four types of cell populations as shown in FIG. 10. The changes in cell population implicitly encoded in the figure can be described by the following equations.

$$\frac{d SC}{d t} = ( {k}_{1} - {k}_{3} - {k}_{4} ) SC$$

$$\frac{d IC}{d t} = ( {k}_{2} + 2 {k}_{3} ) SC + ( {k}_{5} - {k}_{6} ) IC$$

$$\frac{d NC}{d t} = {k}_{4} SC + {k}_{6} IC - {k}_{7} NC$$

Boman at al. have studied (using the Mathematica equation solving system) the sensitivity of several parameters for cell division in a crypt. These include k₁ for symmetric SC division, k₂ for asymmetric SC division and k₅ for symmetric IC division. Their results show that increased symmetric SC division (through an increase in k₁) is the driving force for cancer growth through exponential increase in cell subpopulations.

### Deterministic Modeling of Cell Population Dynamics by Johnston:

In Johnston et at (2007) the researchers have developed a slightly different model for cell population dynamics in a crypt, where NC does not directly depend on SC. In the Johnston model each cell has its own cell cycle driven process of proliferation, differentiation and apoptosis (dying) as shown in FIG. 11.

Although Johnston et al. have addressed the age distribution of cells within their life-cycle, their final model reverts back to the following simple continuous differential equations.

$$\frac{d {N}_{0}}{d t} = ( {\#}_{3} {\#}_{1} {\#}_{2} ) {N}_{0} \\ \frac{d {N}_{1}}{d t} = {{{(}_{3} }_{1}}_{ 2} ) {N}_{1} + {\#}_{2} {N}_{0}$$

$$\frac{d {N}_{2}}{d t} = {}_{2}^{}{N}{}_{1}^{} ! {N}_{2}$$

Here α₁, α₂, α₃ are the probabilities for stems cells to die, to differentiate, and to renew, respectively. Similarly, β₁, β₂, β₃ are the probabilities for semi-differentiated cells to die, to differentiate, and to renew, respectively. Finally, γ represents the probability for fully differentiated cells to die or shed.

Johnston et al. have also attempted to include the effects of feedback on the cell population dynamics by modifying the rate equations for different cell types. For example, the rate of differentiation for stem cells due to the linear feedback is modeled as:

$$\frac{d {N}_{0}}{d t} = ( {α}_{3} - {α}_{1} ) {N}_{0} - {N}_{0} ( {α}_{2} + {k}_{0} {N}_{0} )$$

### Software Framework for Modeling Colorectal Cancer at Multiple Scales:

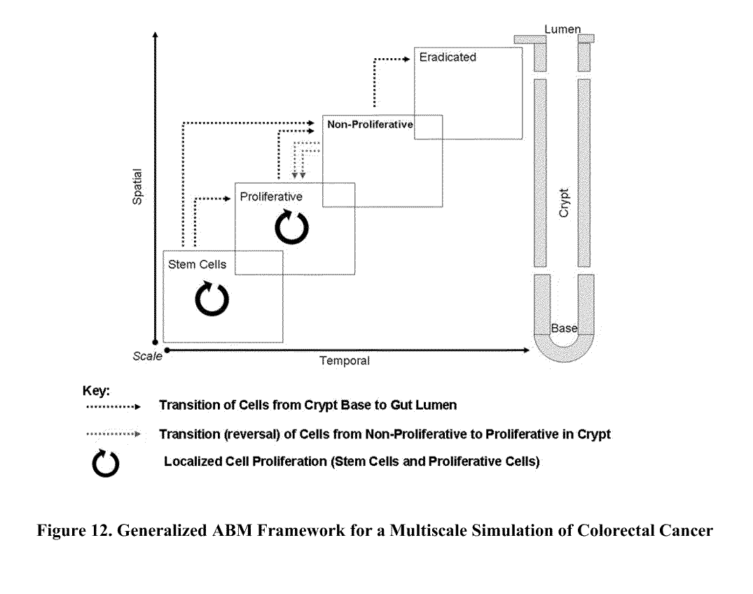

In order to incorporate both cited models a generalized framework that is consistent with the use of an agent-based model (ABM) was developed for the two models. The framework is shown in FIG. 12 and includes a representation of the colonic crypt to show the spatial locations that the ABM panels are designed to represent.

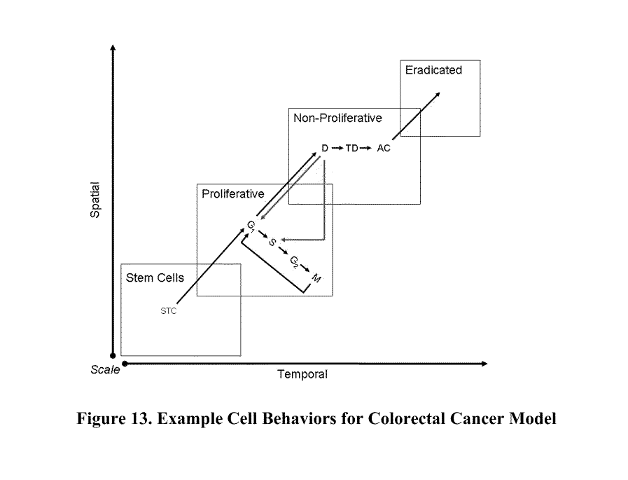

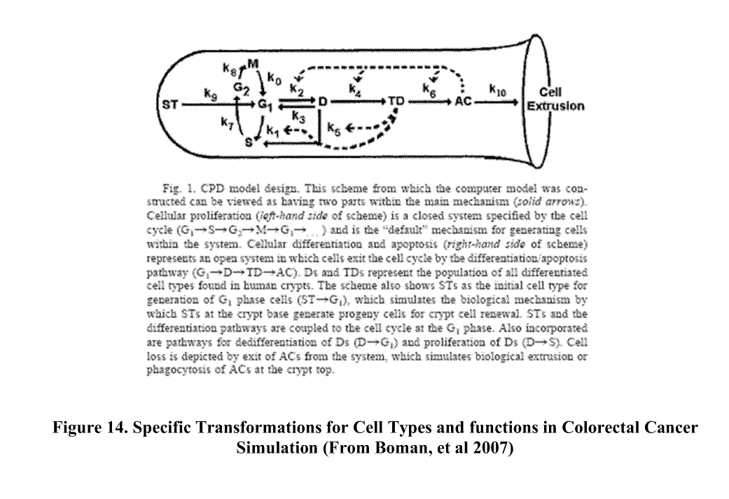

The components (panels) shown in FIG. 12 comprise the model elements that support the simulation. Each panel has distinct temporal and spatial scales and ‘represent’ different cell populations that occur in the colonic crypt and which play a role in normal and cancerous behavior leading to development of the diseased state. The behaviors of the agents in the individual panels and the movement (translocation) of agents between the panels represent changes in cell types and behaviors and also migration of the various cell types within the colonic crypt. Examples of this are shown in FIG. 13.

The ABM behaviors for the agents that represent cell types and cell functions in the panels are linked to specific ordinary differential equations (ODE). The ODE are ‘model components’ described in the previously cited publications of Boman and Johnston as outlined previously. The behavior of the agents can be modified through changes to the ODE and can represent normal cellular function, abnormal cellular function leading to cancerous growth, and options for intervention in progression of the cancerous state through surgical procedures or treatments. An example of the use of ODE to generate model behaviors is shown in FIG. 14 where the specific rate constants are as described previously in FIG. 10.

The data from the ABM is captured at each time point in the simulation in a database. The database provides the basis for development of suitable visualizations of the simulation and for the analysis of the simulation, models and model components.

The analysis and modeling of the simulation can form the basis for principled hypothesis generation and testing as envisioned within the scope of the present invention.

### REFERENCES

Bruce M. Boman, Max S. Wicha, Jeremy Z. Fields, Olaf A. Runquist, Symmetric Division of Cancer Stem Cells—a Key Mechanism in Tumor Growth that should be Targeted in Future Therapeutic Approach, Clinical Pharmacology and Therapeutics, 2007, 81(6), pages 893-898
Matthew D. Johnston, Carina M. Edwards, Walter F. Bodmer, Philip K. Maini and Jonathan Chapman, Mathematical modeling of cell population dynamics in the colonic crypt and in colorectal cancer, PNAS, 2007, 104(10), pages 4004-4013
P. M. Tomlinson, W. F. Bodmer, Failure of programmed cell death and differentiation as causes of tumors: Some simple mathematical models, PNAS, 1995, 92(24), pages 11130-11134

1. In a computer system, having one or more processors or virtual machines, each processor comprising at least one core, one or more memory units, one or more input devices and one or more output devices, optionally a network, and optionally shared memory supporting communication among the processors, a method for automatically identifying at least one informative data filter from a data set that can be used for identifying at least one relevant data subset against a target feature for subsequent hypothesis generation, model building and model testing resulting in more efficient data storage, data management and data utilization comprising the steps of:
(a) selecting at least one informative combination of interacting features from a data set from the one or more memory units using mutual information against the target feature as the selection criterion;
(b) identifying at least one state combination of each selected feature combination that defines an informative data filter, wherein the state combination has a mutual information score that exceeds a threshold mutual information and a data support level that exceeds a threshold data support;
(c) selecting an optimum intersection of the one or more informative data filters of step (b) for generating a data subset consisting of data records that share multiple common feature states for subsequent hypothesis generation model building, model testing against the target feature; and
(d) selecting an optimum union of the one or more informative data filters of step (b) for generating a data subset consisting of data records that have been aggregated across one or more data filters for subsequent hypothesis generation, model building and model testing against the target feature.

2. The method of claim 1 wherein the selection step in (d) results in a triaging of the data set into relevant and irrelevant data subsets for subsequent analysis.

3. The method of claim 1 wherein the selection step in (a) further comprises the steps of:
(a) calculating individual mutual information for each feature against a target feature across a data set;
(b) selecting at least one subset of features from the data set based on the individual mutual information scores; and
(c) selecting at least one combination of interacting features from each selected feature subset where the feature combination has high mutual information.

4. The method of claim 1 wherein the identification step in (b) further comprises the steps of:
(a) defining a threshold mutual information score;
(b) defining a threshold data support level;
(c) searching each interacting feature combination in claim 1(a) for state combinations of the constituent features where the data in the data set that satisfy the corresponding state combinations provide a mutual information score against the target feature that exceeds the threshold mutual information score and further provide data support that exceeds the threshold data support level; and
(d) identifying the state combinations in each feature combination that satisfy the conditions of step (c) as an informative data filter that can be used to select a segment of the data set that is informative against the target feature.

5. The method of claim 1 wherein the selection of an optimum intersection of one or more informative data filters in step (c) for subsequent hypothesis generation, model building and model testing further comprises the steps of:
(a) defining a fitness function that comprises both a data support term and a feature complexity term across one or more intersecting data filters:
fitness function=λ*data support−(1−λ)/(feature complexity),
where λ is a normalized tuning parameter between 0 and 1 that adjusts the relative weighting of data support versus feature complexity; and
(b) searching the space of informative data filters in claim 1(c) for a combination of intersecting data filters that maximize the fitness function of step (a).

6. The method of claim 4 further comprising using a genetic algorithm for searching the space of informative data filters in step (b) for finding an optimum intersection.

7. The method of claim 1 wherein selecting the optimum intersection of data filters in step (c) for subsequent hypothesis generation, model building and model testing further comprises the steps of:
(a) applying the optimum intersection of data filters as a composite data filter against the data set; and
(b) utilizing the subset of data filtered using the composite filter of step (a) for analysis and visualization.

8. The method of claim 6 wherein the application of the optimum intersection of data filters against a data set in step (a) can be performed via a database query resulting in retrieval of a data subset that shares multiple common feature state values.

9. The method of claim 7 wherein the database query can be distributed across one or more distinct databases.

10. The method of claim 6 further comprising performing automatically, through the use of data mining techniques, analysis of the filtered data in step (b) for hypothesis generation, model building and model testing can.

11. The method of claim 9 wherein the data mining techniques are at least one selected from the group consisting of:
decision trees, neural networks, Bayesian network modeling, and linear and non-linear regressions.

12. The method of claim 1 wherein the selection of an optimum union of the one or more informative data filters in step (d) for subsequent hypothesis generation, model building and model testing further comprises the steps of:
(a) generating a profile of the union mutual information score as a function of mutual information threshold ranging from a minimum threshold mutual information score to a maximum threshold mutual information score using the increment level for the mutual information score as the increment parameter;
(b) scanning the profile of step (a) as a function of mutual information threshold for the first discontinuity in the union mutual information that exceeds a mutual information discontinuity threshold and where the discontinuity in data support exceeds a data support discontinuity threshold; and
(c) selecting as the optimum union the corresponding union of one or more informative data filters at the point of discontinuity identified in step (b).

13. The method of claim 1 wherein the selection of the optimum union of data filters in step (d) for subsequent hypothesis generation, model building and model testing further comprises the steps of:
(a) applying the optimum union of data filters as a composite data filter against the data set; and
(b) utilizing the subset of data filtered using the composite filter of step (a) for analysis and visualization.

14. The method of claim 12 wherein the application of the optimum union of data filters against a data set in step (a) can be performed via a database query resulting in the retrieval of relevant data against a target feature.

15. The method of claim 13 wherein the database query can be distributed across one or more distinct databases.

16. The method of claim 12 further comprising performing automatically, through the use of data mining techniques, analysis of the filtered data in step (b) for hypothesis generation, model building and model testing.

17. The method of claim 15 wherein the data mining techniques are at least one selected from the group consisting of:
decision trees, neural networks, Bayesian network modeling, and linear and non-linear regressions.

18. The method of claim 1 wherein the selection of an optimum union of the one or more informative data filters in step (d) for generating a relevant data subset for subsequent hypothesis generation, model building and model testing further comprising the steps of:
(a) generating a profile of the union mutual information score as a function of mutual information threshold ranging from a minimum threshold mutual information score to a maximum threshold mutual information score using the increment level for the mutual information score as the increment parameter;
(b) applying the union of data filters at a corresponding value of the mutual information threshold in (a) as a composite data filter against the training data set to generate a filtered training data set, and against the tuning data set to generate a filtered tuning data set;
(c) building at least one model using the filtered training data set from (b);
(d) evaluating the model or set of models from step (c) using the filtered tuning data set; and
(e) repeating steps (b) through (d) across all values for the mutual information threshold in (a) to identify the optimum model against the filtered tuning data set in step (d) for identification of the optimum union of filters.

19. A method for the automatic identification of at least one informative data filter from a data set that can be used for driving a more computationally efficient and informative dynamic simulation comprising the steps of:
(a) selecting at least one informative combination of interacting features from a data set using mutual information against the target feature as the selection criterion;
(b) identifying at least one state combination of each selected feature combination that defines an informative data filter, wherein the state combination has a mutual information score that exceeds a threshold mutual information and a data support level that exceeds a threshold data support;
(c) associating a simulation entity with at least one informative data filter from step (b); and
(d) selecting a target state associated with the simulation entity stochastically at any point during the simulation using the probabilistic rule encoded by the mutual information score within each informative filter from step (c).

20. The method of claim 19 wherein the selection of the target state in step (d) can be further driven by updated feature state values for each informative filter that are obtained from external data sources during the course of the simulation.

21. A method of creating a computationally efficient, scalable, informative agent-based simulation system using automatically generated models or model components that encode informative emergent behavior of the system by automatically identifying at least one informative filter using the system of claim 1 and further comprising at least one of the steps of:
(a) developing models that support a simulation that encompasses informative emergent behavior by automatically identifying at least one informative filter and further using an approach selected from at least one of the group consisting of:
i. automatically learning models from informative data;
ii. automatically learning rules to guide the development of models;
iii. automatically learning rules to guide combining models; and
iv. modifying automatically learned models or rules to ‘tune’ models to support a simulation system; and
(b) developing a simulation system that encompasses emergent behavior that comprises at least one selected from the group consisting of:
i. simulating a system at multiple scales;
ii. simulating a system using multiple models; and
iii. simulating a system using multiple modalities.

22. A simulation engine comprising a computer system, having one or more processors or virtual machines, each processor comprising at least one core, the system comprising one or more memory units, one or more input devices and one or more output devices, optionally a network, and optionally shared memory supporting communication among the processors for rapid simulation of complex or complex adaptive systems realized through the dynamic interaction of multiple models or modeling components capable of generating outputs suited to teaching, training, experimentation and decision support comprising:
(a) means for automatically learning models from informative data located on the one or more memory units; and
(b) means of developing a simulation system using a method that includes least one selected from the group consisting of:
i. simulating a system at multiple scales
ii. simulating a system using multiple models
iii. simulating a system using multiple modalities that enables at least one of:
a. in silico experimentation and analysis of a complex system or a complex adaptive system;
b. in virtuo experimentation and analysis of a complex system or a complex adaptive system; and
c. in silico or in virtuo experimentation, analysis, modeling or representation of a biological system capable of being studied by at least one of the methods described as:
i. in vitro;
ii. in vivo; and
iii. ex vivo.

23. The method of claim 21 wherein the system further comprises at least one selected from the group consisting of:
a complex system and a complex adaptive system.

24. The method of claim 21 wherein the models learned in step (a) exhibit characteristics that comprise at least one selected from the group consisting of:
complete, incomplete, partial, distributed, signal-rich and informative.

25. The method of claim 21 wherein the scales described in step (b) comprise at least one selected from the group consisting of:
biological systems defined by one or more of the -Omes Continuum and -Omics Continuum.

26. The method of claim 21 wherein the modalities described in step (b) comprise at least one selected from the group consisting of:
images, text, computer language, movement and sound.

27. The method of claim 21 wherein the models described in step (b) comprise at least one selected from the group consisting of:
complete, incomplete, partial, distributed, signal-rich and informative.

28. The method of claim 21 wherein the automatic learning of models from informative data in step (a) is enabled by the use of data-mining techniques.

29. The method of claim 21 where the informative emergent behavior of the system is enabled by the inclusion of either deterministic terms or stochastic terms or both deterministic and stochastic terms into the model components or models.

30. A method of linking systems biology with data information using the method of claim 21.

31. In a computer system, having one or more processors or virtual machines, each processor comprising at least one core, one or more memory units, one or more input devices and one or more output devices, optionally a network, and optionally shared memory supporting communication among the processors, a method of increasing manufacturing yield using at least one informative data filter, wherein the informative data filter is at least one manufacturing parameter;
the method comprising automatically identifying at least one informative data filter from a data set for identifying at least one relevant data subset against a target feature for subsequent hypothesis generation, model building and model testing that can result in more efficient use of materials comprising the steps of:
(a) selecting at least one informative combination of interacting features from a data set from the one or more memory units using mutual information against the target feature as the selection criterion;
(b) identifying at least one state combination of each selected feature combination that defines an informative data filter, wherein the state combination has a mutual information score that exceeds a threshold mutual information and a data support level that exceeds a threshold data support;
(c) selecting an optimum intersection of the one or more informative data filters of step (b) for generating a data subset consisting of data records that share multiple common feature states for subsequent hypothesis generation model building, model testing against the target feature; and
(d) selecting an optimum union of the one or more informative data filters of step (b) for generating a data subset consisting of data records that have been aggregated across one or more data filters for subsequent hypothesis generation, model building and model testing against the target feature.

32. In a computer system, having one or more processors or virtual machines, each processor comprising at least one core, one or more memory units, one or more input devices and one or more output devices, optionally a network, and optionally shared memory supporting communication among the processors, a method of improving healthcare diagnosis and treatment using at least one informative data filter, wherein the informative data filter is at least one health statistic; the method comprising automatically identifying of at least one informative data filter from a data set for identifying at least one relevant data subset against a target feature for subsequent hypothesis generation, model building and model testing comprising the steps of:
(a) selecting at least one informative combination of interacting features from a data set from the one or more memory units using mutual information against the target feature as the selection criterion;
(b) identifying at least one state combination of each selected feature combination that defines an informative data filter, wherein the state combination has a mutual information score that exceeds a threshold mutual information and a data support level that exceeds a threshold data support;
(c) selecting an optimum intersection of the one or more informative data filters of step (b) for generating a data subset consisting of data records that share multiple common feature states for subsequent hypothesis generation model building, model testing against the target feature; and
(d) selecting an optimum union of the one or more informative data filters of step (b) for generating a data subset consisting of data records that have been aggregated across one or more data filters for subsequent hypothesis generation, model building and model testing against the target feature.
